(19) United States
(12) Patent Application Publication
(10) Pub. No.: US 2010/0237246 A1
(43) Pub. Date: Sep. 23, 2010

(54) Evaluation device for evaluating measuring signals, measuring device and method for receiving and evaluating measuring signals

(76) Inventors: Paul Koop, Stuttgart (DE); Helge Dittmer, Tuebingen (DE)

Correspondence Address: KENYON & KENYON LLP, ONE BROADWAY, NEW YORK, NY, 10004, US

(21) Appl. No.: 12/661,455

(22) Filed: Mar. 16, 2010

(30) Foreign Application Priority Data
Mar. 18, 2009 (DE) 10 2009 001 627.9

(51) Int. Cl. G01N 21/35; H04B 15/00; G01J 5/30; G01J 5/02

(52) U.S. Cl. 250/338.3; 702/189; 702/191; 250/339.07; 250/339.06

(57) ABSTRACT

An evaluation device for evaluating analog measuring signals of a detector, e.g., an IR detector, includes: an analog/digital converter device for digitally converting the analog measuring signal of the detector or an analog signal derived from the analog measuring signal into a digital measuring signal; a control device for receiving the digital measuring signal; and a subtraction device. The evaluation device receives a first analog measuring signal from a first measurement and stores the digital measuring signal formed from the first analog measuring signal, and also receives a second analog measuring signal from a second measurement. The subtraction device receives the analog measuring signal of the second measurement and an analog comparison signal formed as a function of the stored digital measuring signal of the first measurement, and forms a differential signal.

### BACKGROUND OF THE INVENTION

1. Field of the Invention

The present invention relates to an evaluation device and a method for evaluating analog measuring signals of a detector.

2. Description of Related Art

In spectroscopic gas sensor technology, various detectors and methods are used for converting infrared radiation (IR radiation) to electrical voltage signals, in which the IR radiation is absorbed, and the temperature is ascertained that sets in as a function of the intensity of the incident IR radiation. In thermopile elements the Seebeck effect is used. In a pyroelectric detector the pyroelectric effect is utilized, in which an electric voltage is generated in a piezoelectric crystal, which assumes different values at different temperatures. The analog measuring signal is generally picked up by an evaluation device, which has an analog/digital converter device for the digitization of the analog measuring signal or of the amplified analog signal, and furthermore has a control device for picking up the digital measuring signal thus formed.

In detectors of the second kind, temperature changes over time are ascertained, so that the detector may be irradiated in a pulsed fashion, for example. The disadvantage of such detectors is, however, that they are generally subject to a superposed offset voltage, which is frequently considerably larger than the actual useful signal, and whose amount depends on various factors, such as manufacturing tolerances and component ageing. Since the useful signal is only in the range of a few millivolt, for example, it is usually greatly amplified for an exact evaluation. However, this has the disadvantage that the offset voltage is correspondingly also amplified.

Noise filters are known for signal conditioning which detect and suppress noise as high-frequency signal components; because of this, however, the underlaid offset voltage is not able to be ascertained or taken into account.

### BRIEF SUMMARY OF THE INVENTION

The present invention provides an evaluation device for evaluating measuring signals and for picking and evaluating measuring signals, a measuring device having this evaluation device, as well as a method for picking up and evaluating measuring signals.

The present invention is based on the idea of subtracting the offset voltage already from the analog measuring signal, that is, from the analog/digital conversion, and for this to carry out measurements in at least two different measuring states, in which one may expect a change in the offset voltage that is preferably none or only a slight one. A first measurement in a first measuring state may advantageously be carried out, in which, in addition to the offset voltage, no further useful signal is to be expected, so that this first measuring signal is directly ascertained as an offset voltage.

According to the present invention, the storage of the analog offset voltage advantageously takes place as digital, so that an analog/digital conversion of the first measuring signal, digital storage and subsequent output of the digital value of the offset voltage having digital/analog conversion takes place, so that one may then subtract the analog offset voltage from the measuring signal of the second measurement.

Thus, in a first measurement, the analog measuring signal is ascertained in a first measuring state, which, in an IR detector, may be in particular at switched-off IR radiation source. This first measurement is thus able to be used directly for ascertaining the offset voltage. The subsequent second measurement in the second measuring state is used as the actual measurement; in an IR detector it may thus take place in the case of a switched-on IR radiation source.

In the second measurement, the digital measuring signal stored in the first measurement is thus carried through again into an analog measuring signal; and for this one may use the stored digital measuring signal directly, or a signal formed from it. This analog comparison signal is subtracted from the now ascertained analog measuring signal, and this is done already in the analog range, that is, by an analog subtraction device that is known per se. Consequently, an analog differential signal is ascertained which is subsequently able to be optionally amplified and filtered, and is digitized again, so that a digital differential signal is obtained as the result of the actual measurement.

The two measurements are advantageously carried out directly consecutively, so that the environmental conditions of the detector, and thus its offset voltage as much as possible do not change, or change only slightly. By using pulsed radiation, for example, the measurements may be synchronized with the pulse duration of the radiation source, or may be multiples of one another.

In this connection, the present invention has a few advantages. The parasitic offset voltage may be compensated for directly in the analog range, so that subsequently a large amplification of the useful signal is possible at low operating voltages and without adjusting the evaluation circuit. For this, the amplification and the filtering may be adjusted respectively. By currently ascertaining the offset voltage according to the present invention, a more accurate result may be achieved than, for instance, by making a subsequent subtraction of a value that was once ascertained ahead of time. A measuring result that is qualitatively good may thus be obtained.

A filtering to produce noise suppression may be carried out optionally on the analog useful signal or on the signal acquired by digitation.

### BRIEF DESCRIPTION OF THE SEVERAL VIEWS OF THE DRAWING

FIG. 1 shows an example embodiment of a measuring device according to the present invention for measuring a radiation intensity.

FIG. 2 shows a flow chart of an example measuring method according to the present invention.

### DETAILED DESCRIPTION OF THE INVENTION

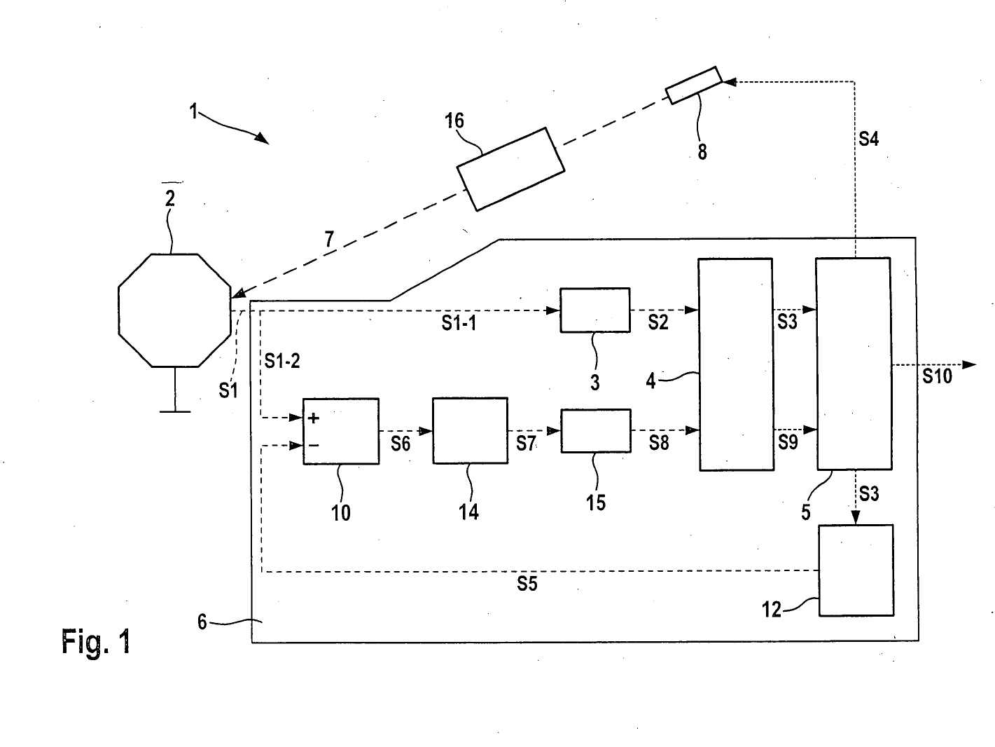

A measuring device 1, shown in FIG. 1, is used for measuring the intensity of incident IR radiation 7. It has a detector 2 which receives incident IR radiation 7. Detector 2 is advantageously a pyroelectric detector which heats up as a function of the intensity of incident IR radiation 7, and emits a measuring signal S1, as the analog voltage signal, as a function of its temperature. Furthermore, however, detector 2 may also be a thermopile sensor, for example, which is formed, for instance, by a cascading of a plurality of thermopile elements, which are each formed by the contacting of printed circuit traces made of materials having different Seebeck coefficients, and which generate analog measuring signal S1 as a function of the temperature differences of their contact points. Moreover, detector 2 may also carry out a bolometric measurement.

Detector 2 passes analog measuring signal S1 to an evaluation device 6 according to the present invention, which include components 3, 4, 5, 10, 12, 14, 15, that are described in greater detail below. In this connection analog measuring signal S1 is first passed to an analog filter 3 for noise suppression, which outputs a filtered analog measuring signal S2 to an analog/digital converter (ADC) 4, which performs a digitization of analog measuring signal S2 and outputs a digital measuring signal S3 to a control device 5, which may be a microprocessor. Control device 5 controls an IR radiation source 8 using control signals S4; alternatively, IR radiation source 8 may also be controlled by an additional control device, and control device 5 may be informed about the respective state of IR radiation source 8 by a corresponding state signal.

Analog measuring signal S1 is composed essentially of a useful signal and an offset, in this instance, this offset being dependent on various factors, such as manufacturing tolerances of detector 2, of its component support, of the environmental temperature, etc., but not at all, or essentially not by the intensity of IR radiation 7.

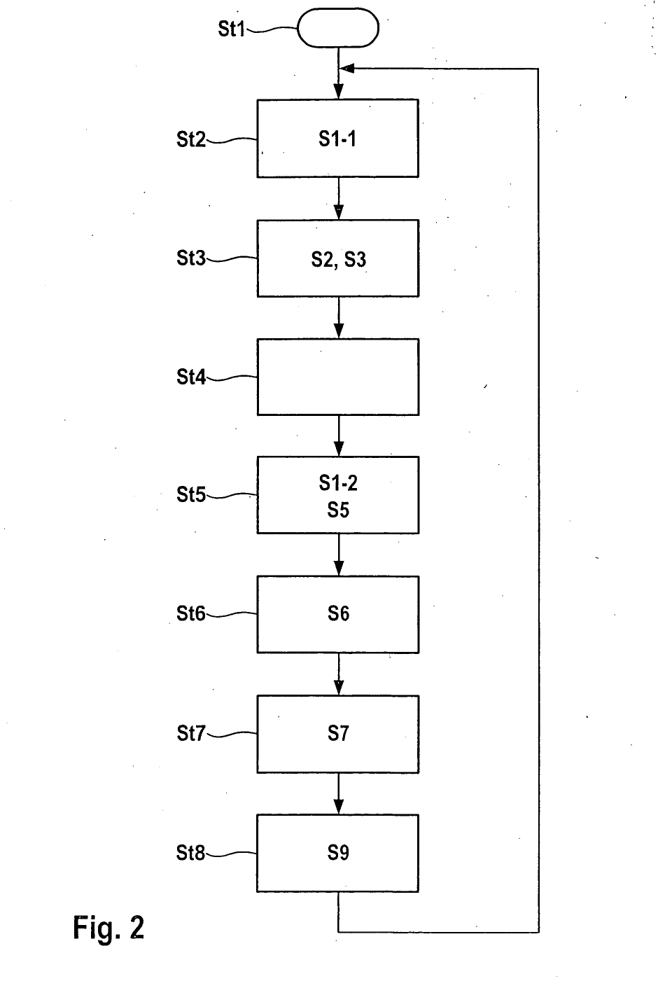

According to FIG. 2, the measurement is started in a step St1, according to the present invention, and subsequently, in step St2 a first measurement is performed at first without incident IR radiation 7, that is, when IR radiation source 8 is switched off. Consequently, first analog measuring signal S1-1 of the first measurement is formed essentially by the offset, or rather the offset voltage. First analog measuring signal S1-1 is filtered in step St3 and digitized by ADC 4 and stored in step St4 as the first digital measuring signal S3 by control device 5 for the subsequent measurement; this storage may occur internally in control device 5, or even externally.

In subsequent step St5, IR radiation source 8 is switched on so that IR radiation 7 impinges upon IR detector 2, and the latter outputs a second analog measuring signal S1-2, as a function of incident IR radiation 7. Second measuring signal S1-2 is supplied to a subtractor 10 at its plus input. In addition, control device 5 passes first digital measuring signal S3, that was stored at the first measurement, or a digital measuring signal calculated from the latter, to a digital/analog converter 12, which thus outputs an analog comparison signal S5 to the minus input of subtractor 10.

Consequently, analog comparison signal S5 corresponds to first analog measuring signal S1-1 of the first measurement or comparative measurement, and thus essentially represents the analog offset voltage. Subsequently, in step St6, subtractor 10 outputs an ascertained analog differential signal S6 to an amplifier 14, which consequently outputs an amplified differential signal S7 to a filter 15, which, in turn, outputs a filtered analog differential signal S8 to analog/digital converter 4. For this purpose, analog/digital converter 4 may have two channels; alternatively, however, filter 15 may be identical to filter 3, so that the signals run via the same channel of analog/digital converter 4. Subsequently, in step St7, analog/digital converter 4 passes a digital differential signal S9 to control device 5, which in step St8 temporarily stores this signal or conditions it further and outputs an output signal S10 as a function thereof as the result, S10 being also able to be identical to S9.

Measuring device 1 according to the present invention may, in particular, be used as a spectroscopic gas sensor, by having IR radiation 7, that is output by IR radiation source 8, pass through a measuring path 16, in which, for instance, a gas mixture is accommodated, in which the concentration of relevant gases or gas components is to be determined. IR radiation 7 is absorbed correspondingly to the concentration of relevant gases or gas components, such as the proportion of carbon dioxide. In this connection, a spectral filter, that is not shown here, may optionally be applied in front of detector 2, in order to filter out a relevant wave length range of the IR radiation.

Basically, it is also possible to carry out the first measurement not as an empty measurement having a switched-off radiation source 8, but so as to draw upon different controls of the radiation source 8 for the two measurements, and subsequently to determine the offset from the difference of measuring signals S1-1 and S2-2 or even additional measuring signals. According to the present invention, however, a great advantage is achieved in a first measurement having switched-off radiation source 8, since first analog measuring signal S1-1 is able to be evaluated directly as the offset voltage.

Detector 2, according to the present invention, may also be a detector of another measuring type, which is used in two consecutive measurements, i.e. an empty measurement or measurement in the case of a switched-off action of a physical quantity, and a subsequent actual measurement, using which a useful signal is able to be separated from an offset voltage that is the same or approximately the same in both measurements.

The entire evaluation device 6 may be developed as an integrated switching circuit.

What is claimed is:

1. An evaluation device for evaluating an analog measuring signal of a detector, comprising:
an analog/digital converter device configured to receive and convert one of a first analog measuring signal measured in a first measurement using the detector or an analog signal derived from the first analog measuring signal into a digital measuring signal;
a control device configured to receive and store the digital measuring signal; and
a subtraction device configured to receive as inputs (a) a second analog measuring signal measured in a second measurement using the detector and (b) an analog comparison signal derived from the stored digital measuring signal, wherein the subtraction device generates an analog differential signal based on the received inputs.

2. The evaluation device as recited in claim 1, further comprising:
a digital/analog converter device configured to form the analog comparison signal from the stored digital measuring signal output by the control device;
wherein the subtraction device subtracts the analog comparison signal as offset from the analog measuring signal of the second measurement.

3. The evaluation device as recited in claim 2, wherein the control device influences a device external to the evaluation device differently in the first and second measurements, wherein the device external to the evaluation device is a device for influencing a variable measured by the detector.

4. The evaluation device as recited in claim 2, wherein at least the analog/digital converter device receives and digitizes one of the analog differential signal generated by the subtraction device or an analog signal derived from the analog differential signal.

5. The evaluation device as recited in claim 4, further comprising:
an amplification device configured to receive and amplify the analog differential signal.

6. The evaluation device as recited in claim 4, further comprising:
at least one filtering device for noise suppression, wherein the filtering device filters at least one of (a) the first analog measuring signal, (b) the digital measuring signal, (c) the analog differential signal, or (d) a signal derived from the analog differential signal.

7. A measuring device, comprising:
a detector configured to measure and output a first analog measuring signal in a first measurement and a second analog measuring signal in a second measurement;
an evaluation device including:
an analog/digital converter device configured to receive and convert one of the first analog measuring signal measured or an analog signal derived from the first analog measuring signal into a digital measuring signal;
a control device configured to receive and store the digital measuring signal; and
a subtraction device configured to receive as inputs (a) the second analog measuring signal and (b) an analog comparison signal derived from the stored digital measuring signal, wherein the subtraction device generates an analog differential signal based on the received inputs; and
a further device operationally connected to the control device and configured to influence a variable measured by the detector differently in the first and second measurements, wherein the control device at least one of (i) outputs control signals to the further device for influencing the measured variable and (ii) receives from the further device state signals concerning the influencing of the measured variable.

8. The measuring device as recited in claim 7, wherein:
the detector is an infrared radiation detector;
the further device is an infrared radiation source for emitting infrared radiation;
the detector is configured to detect at least a part of the infrared radiation emitted by the infrared radiation source; and
the infrared radiation source is switched off in the first measurement and switched on in the second measurement.

9. The measuring device as recited in claim 8, wherein the detector is one of a pyroelectric detector or a thermopile detector.

10. The measuring device as recited in claim 8, wherein:
the measuring device is a part of a spectroscopic gas sensor;
the infrared radiation emitted by the infrared radiation source passes through a measuring path; and
based on the first and second measurements, the control device ascertains a concentration of a gas component of the measuring path and outputs an output signal corresponding to the ascertained concentration of the gas component.

11. A method for evaluating measuring signals, comprising:
receiving a first analog measuring signal from a first measurement performed by a detector;
performing an analog-to-digital conversion of the first analog measuring signal to form a digital measuring signal;
storing the digital measuring signal;
receiving a second analog measuring signal from a second measurement performed by the detector;
generating an analog comparison signal based on the stored digital measuring signal;
generating an analog differential signal based on the second analog measuring signal and the analog comparison signal; and
performing a digital-to-analog conversion of one of the analog differential signal or an analog signal derived from the analog differential signal.
